(19) United States
(12) Patent Application Publication
(10) Pub. No.: US 2003/0099178 A1
(43) Pub. Date: May 29, 2003

(54) Optical disc drive and laser beam drive power supply voltage control method

(76) Inventor: Hirokazu Sho, Kawasaki-shi (JP)

Correspondence Address: PILLSBURY WINTHROP, LLP, P.O. BOX 10500, MCLEAN, VA, 22102, US

(21) Appl. No.: 10/214,100

(22) Filed: Aug. 8, 2002

(30) Foreign Application Priority Data
Nov. 29, 2001 (JP) 2001-364809

(51) Int. Cl. G11B 7/125

(52) U.S. Cl. 369/53.26; 369/116

(57) ABSTRACT

An optical disc drive according to an embodiment of this invention controls to vary the power supply voltage to be supplied from a power supply section to a drive section, which is configured to drive a laser beam emitting section, so as to maintain consumption power in the drive section constant, in accordance with the operation state of the laser beam emitting section.

### CROSS-REFERENCE TO RELATED APPLICATIONS

This application is based upon and claims the benefit of priority from the prior Japanese Patent Application No. 2001-364809, filed Nov. 29, 2001, the entire contents of which are incorporated herein by reference.

### BACKGROUND OF THE INVENTION

1. Field of the Invention

The present invention relates to an optical disc drive for recording data on an optical disc and reproducing data recorded on the optical disc by irradiating it with a laser beam, and also to a laser beam drive power supply voltage control method for controlling the level of a power supply voltage supplied to a drive section that drives a laser beam irradiation section.

2. Description of the Related Art

In recent years, optical disc drives that record data on an optical disc and reproduce data recorded on the optical disc by irradiating the optical disc with a laser beam have been extensively studied and developed. An optical disc drive has a function of controlling the amount of a laser beam with which an optical disc is irradiated to be constant. For example, a laser beam emitted by a laser diode is split by a beam splitter into a laser beam with which an optical disc is irradiated via an objective lens, and a laser beam with which a photodetector is irradiated. The photodetector photoelectrically converts the irradiated laser beam, and outputs an electrical signal. An error amplifier compares the level of this electrical signal with that of a reference current, and outputs an error signal. A laser drive section amplifies the error signal to make the current level of the error signal to be equal to an internal current level, thus driving the laser diode. In this way, the amount of the laser beam emitted by the laser diode is controlled to be constant.

However, since the operation voltage characteristics of the laser diode change in accordance with a laser drive current, as shown in FIG. 6, the laser drive section operates based on a differential voltage between a power supply voltage and the maximum operation voltage of the laser diode. For this reason, when the operation voltage of the laser diode is low, the differential voltage between that low operation voltage and the maximum operation voltage of the laser diode is consumed by the laser drive section. Hence, when the operation voltage of the laser diode is low, the laser drive section consumes more electric power than that at the maximum operation voltage of the laser diode.

As a feature of the laser diode, its I-L characteristics change in accordance with temperature, as shown in FIG. 7. For this reason, in addition to the above problem, heat generated by the laser drive section raises ambient temperature, which results in a temperature rise of the laser diode, and the I-L characteristics change. As shown in FIG. 8, when the laser diode is driven in accordance with a predetermined current waveform to generate a light waveform, light waveforms with different laser beam amounts are generated due to a change in temperature of the laser diode.

### BRIEF SUMMARY OF THE INVENTION

It is an object of the present invention to solve the aforementioned problems.

(1) An optical disc drive according to an aspect of the present invention controls to vary the power supply voltage to be supplied from a power supply unit to a drive section, which is configured to drive a laser beam emitting section, so as to maintain consumption power in the drive section constant, in accordance with the operation state of the laser beam emitting section.

(2) A laser beam drive power supply voltage control method according to an aspect of the present invention controls to vary the power supply voltage to be supplied from a power supply unit to a drive section, which is configured to drive a laser beam emitting section in an optical disc drive, so as to maintain consumption power in the drive section constant, in accordance with the operation state of the laser beam emitting section.

Additional objects and advantages of the invention will be set forth in the description which follows, and in part will be obvious from the description, or may be learned by practice of the invention. The objects and advantages of the invention may be realized and obtained by means of the instrumentalities and combinations particularly pointed out hereinafter.

### BRIEF DESCRIPTION OF THE SEVERAL VIEWS OF THE DRAWING

The accompanying drawings, which are incorporated in and constitute a part of the specification, illustrate presently preferred embodiments of the invention, and together with the general description given above and the detailed description of the preferred embodiments given below, serve to explain the principles of the invention.

FIG. 1 is a schematic block diagram showing the arrangement of an optical disc drive according to the first embodiment of the present invention;

FIG. 2 is a schematic block diagram showing the arrangement of an optical disc drive according to the second embodiment of the present invention;

FIG. 3 is a schematic block diagram showing the arrangement of an optical disc drive according to the third embodiment of the present invention;

FIG. 4 is a schematic block diagram showing the arrangement of an optical disc drive according to the fourth embodiment of the present invention;

FIG. 5 is a flow chart showing a laser beam drive power supply voltage control method according to an embodiment of the present invention;

FIG. 6 is a graph showing an example of the operation voltage characteristics of a laser diode;

FIG. 7 is a graph showing an example of the temperature-dependent light amount characteristics of the laser diode; and

FIG. 8 is a graph showing an example of the light waveforms of the laser diode at an identical current level at different temperatures.

### DETAILED DESCRIPTION OF THE INVENTION

Preferred embodiments of the present invention will be described hereinafter with reference to the accompanying drawings.

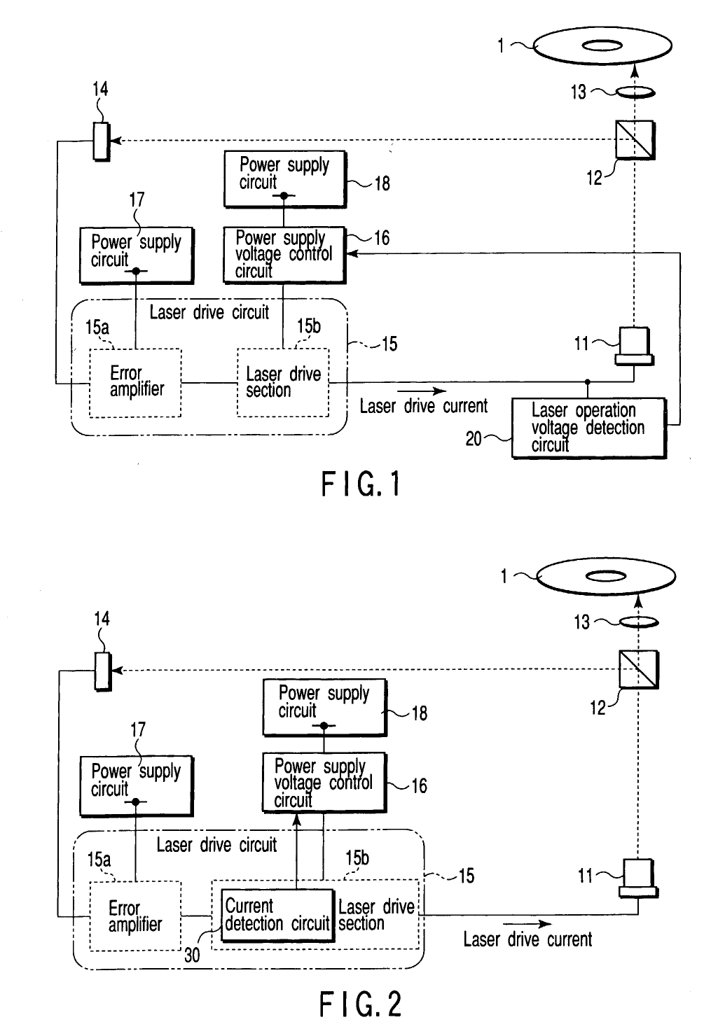

FIG. 1 is a schematic block diagram showing the arrangement of an optical disc drive according to the first embodiment of the present invention. This optical disc drive irradiates an optical disc 1 with a laser beam to record data on the optical disc 1 or to reproduce data recorded on the optical disc 1.

As shown in FIG. 1, the optical disc drive comprises a laser diode 11, beam splitter 12, photodetector 14, laser drive circuit 15, power supply voltage control circuit 16, power supply circuits 17 and 18, and laser drive voltage detection circuit 20. Also, the laser drive circuit 15 comprises an error amplifier 15a and laser drive section 15b.

The power supply circuit 18 is connected to the laser drive section 15b via the power supply voltage control circuit 16. The laser drive section 15b drives the laser diode 11. A laser beam emitted by the laser diode 11 is split by the beam splitter 12 into a laser beam with which the optical disc 1 is irradiated via the objective lens 13, and a laser beam with which the photodetector 14 is irradiated. The photodetector 14 photoelectrically converts the irradiated laser beam, and outputs an electrical signal. The output destination of this electrical signal is the laser drive circuit 15. That is, the laser beam emitted by the laser diode 11 is converted into an electrical signal, which is fed back to the laser drive circuit 15.

More specifically, the output destination of the electrical signal is the error amplifier 15a in the laser drive circuit 15. The power supply circuit 17 is connected to the error amplifier 15a, in which a reference current is present. The error amplifier 15a compares the level of the electrical signal output from the photodetector 14 with that of the reference current, and outputs an error signal.

The error signal output from the error amplifier 15a is input to the laser drive section 15b. The laser drive section 15b amplifies the error signal. The laser drive section 15b drives the laser diode 11 on the basis of the power supply voltage supplied from the power supply circuit 18, and the amplified error signal.

On the other hand, the laser drive voltage detection circuit 20 detects a laser operation voltage level generated by the laser diode 11, which is driven by the laser drive section 15b, and outputs the detection result to the power supply voltage control circuit 16. The power supply voltage control circuit 16 controls the power supply voltage level to be supplied to the laser drive section 15b on the basis of the detection result. Thus, the power supply voltage control circuit 16 controls the power supply voltage level to be supplied to the laser drive section 15b in accordance with the laser operation voltage level. That is, even when the laser operation voltage level has changed, an increase in electric power consumed by the laser drive section 15b can be suppressed.

In other words, the power supply voltage control circuit 16 controls the power supply voltage level to be supplied to the laser drive section 15b to maintain consumption power in the laser drive section 15b constant. Consequently, an ambient temperature rise due to heat generated by the laser drive section 15b can be suppressed.

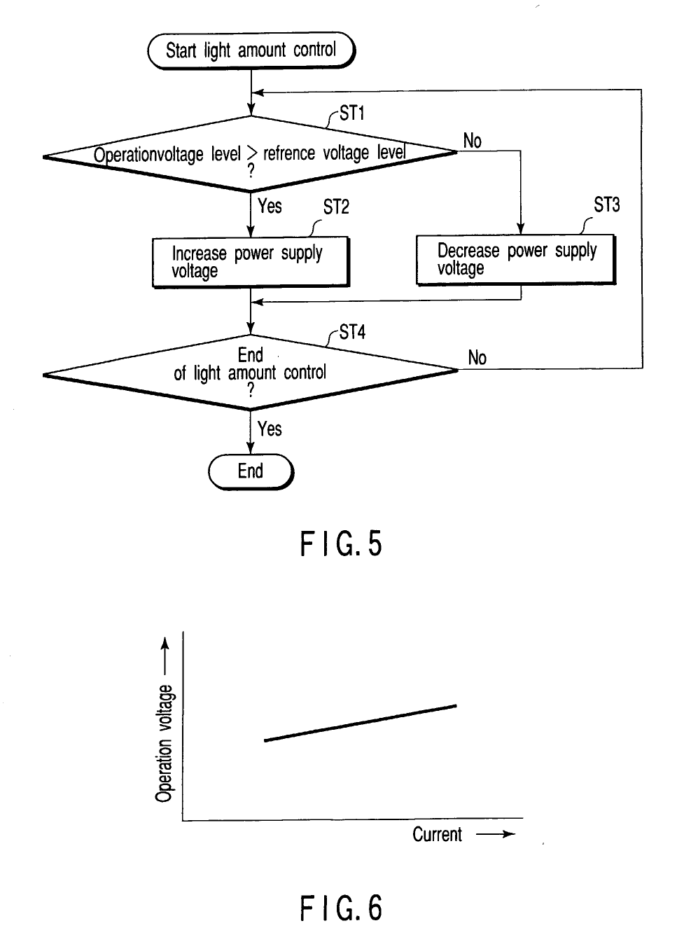

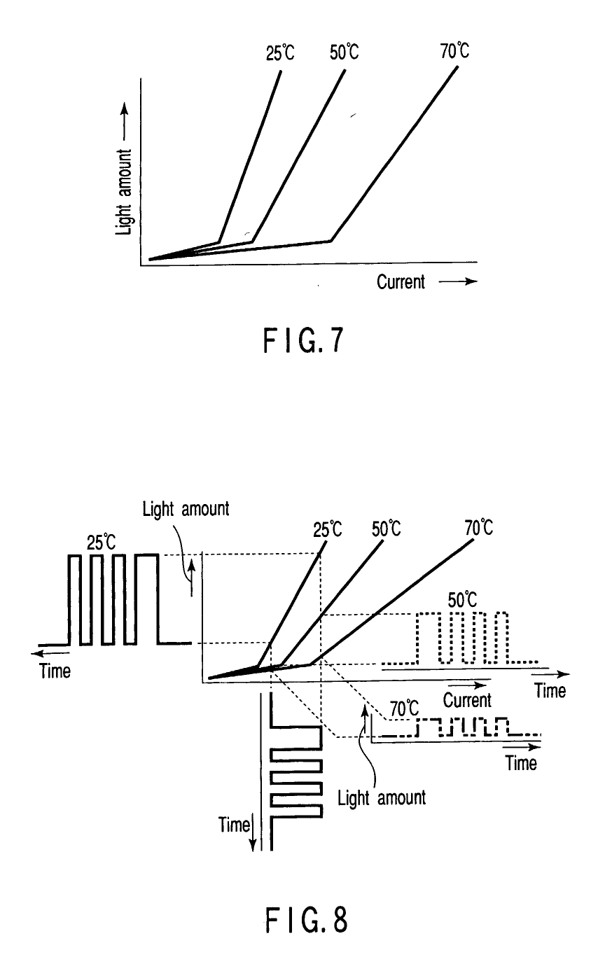

FIG. 5 is a flow chart showing an example of a laser beam drive power supply voltage control method applied to the optical disc drive according to an embodiment of the present invention.

Upon starting the light amount control, the power supply voltage control circuit 16 controls the power supply voltage level to be supplied to the laser drive section 15b to suppress consumption power in the laser drive section 15b. For example, the power supply voltage level supplied from the power supply circuit 18 to the laser drive section 15b is controlled in accordance with the laser operation voltage level generated by the laser diode 11, which is driven by the laser drive section 15b. More specifically, if the laser operation voltage level detected by the laser operation voltage detection circuit 20 is higher than the reference voltage level (ST1, YES), the power supply voltage control circuit 16 increases the power supply voltage level to be supplied to the laser drive section 15b (ST2). Conversely, if the laser operation voltage level detected by the laser operation voltage detection circuit 20 is equal to or lower than the reference voltage level (ST1, NO), the power supply voltage control circuit 16 decreases the power supply voltage level to be supplied to the laser drive section 15b (ST3). The power supply voltage control continues until the light amount control ends (ST4).

FIG. 2 is a schematic block diagram showing the arrangement of an optical disc drive according to the second embodiment of the present invention. The optical disc drives shown in FIGS. 2 and 1 have the same basic arrangement except for some components. The same reference numerals denote the same parts, and a description thereof will be omitted. The optical disc drive shown in FIG. 2 comprises a current detection circuit 30.

The current detection circuit 30 detects a laser operation current level generated by the laser diode 11, which is driven by the laser drive section 15b, and outputs the detection result to the power supply voltage control circuit 16. The power supply voltage control circuit 16 controls the power supply voltage level to be supplied to the laser drive section 15b on the basis of this detection result. That is, the power supply voltage control circuit 16 controls the power supply voltage level to be supplied to the laser drive section 15b in accordance with the laser operation current level. Thus, even when the laser operation current level has changed, an increase in consumption power in the laser drive section 15b can be suppressed. In other words, the power supply voltage control circuit 16 controls the power supply voltage level to be supplied to the laser drive section 15b to maintain consumption power in the laser drive section 15b constant. Consequently, the ambient temperature rise due to heat generated by the laser drive section 15b can be suppressed.

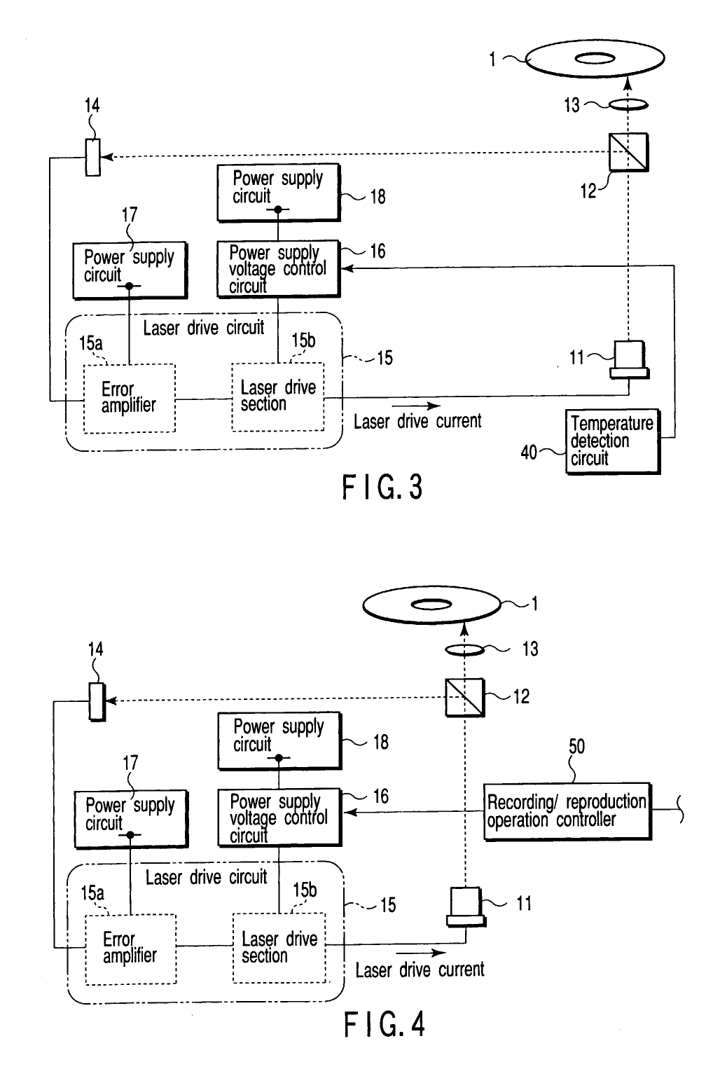

FIG. 3 is a schematic block diagram showing the arrangement of an optical disc drive according to the third embodiment of the present invention. The optical disc drives shown in FIGS. 3 and 1 have the same basic arrangement except for some components. The same reference numerals denote the same parts, and a description thereof will be omitted. The optical disc drive shown in FIG. 3 comprises a temperature detection circuit 40. As has been explained previously, light waveforms with different laser beam amounts are generated due to a change in temperature of the laser diode. The third embodiment solves this problem.

The temperature detection circuit 40 detects the temperature around the laser diode 11, and outputs the detection result to the power supply voltage control circuit 16. The power supply voltage control circuit 16 controls the power supply voltage level to be supplied to the laser drive section 15b on the basis of this detection result. That is, the power supply voltage control circuit 16 controls the power supply voltage level to be supplied to the laser drive section 15b in accordance with the temperature level around the laser diode 11. That is, even when the temperature level around the laser diode 11 has changed, an increase in consumption power in the laser drive section 15b can be suppressed. In other words, the power supply voltage control circuit 16 controls the power supply voltage level to be supplied to the laser drive section 15b to maintain consumption power in the laser drive section 15b constant. Consequently, an ambient temperature rise due to heat generated by the laser drive section 15b can be suppressed.

FIG. 4 is a schematic block diagram showing the arrangement of an optical disc drive according to the fourth embodiment of the present invention. The optical disc drives shown in FIGS. 4 and 1 have the same basic arrangement except for some components. The same reference numerals denote the same parts, and a description thereof will be omitted. The optical disc drive shown in FIG. 4 comprises a recording/reproduction operation controller 50. In general, the amount of light used to record data on an optical disc is different from that used to reproduce data recorded on the optical disc. Recording requires stronger optical power.

The recording/reproduction operation controller 50 controls recording/reproduction for recording data on the optical disc and reproducing data recorded on the optical disc by laser beam emitted by the laser diode 11. The recording/reproduction control state of the recording/reproduction operation controller 50 is reported to the power supply voltage control circuit 16. The power supply voltage control circuit 16 controls the power supply voltage level to be supplied to the laser drive section 15b on the basis of the reported recording/reproduction control state. That is, the power supply voltage control circuit 16 controls the power supply voltage level to be supplied to the laser drive section 15b in accordance with the recording/reproduction control state (i.e., the required optical power). Thus, even when the recording/reproduction control state has changed, an increase in consumption power in the laser drive section 15b can be suppressed. In other words, the power supply voltage control circuit 16 controls the power supply voltage level to be supplied to the laser drive section 15b to maintain consumption power in the laser drive section 15b constant. Consequently, an ambient temperature rise due to heat generated by the laser drive section 15b can be suppressed.

According to the present invention, an optical disc drive, which can maintain consumption power in a laser drive section constant by controlling the amount of a laser beam emitted by a laser diode to be constant, can be provided. Also, according to the present invention, a laser beam drive power supply voltage control method, which can maintain consumption power in a laser drive section constant by controlling the amount of a laser beam emitted by a laser diode to be constant, can be provided.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An optical disc drive comprising:
an emitting section configured to emit a disc with a laser beam;
a photoelectric converting section configured to convert the laser beam into an electrical signal, and output the converted electrical signal;
an error detection section configured to compare a level of the electrical signal with a level of a reference electrical signal, and output an error signal;
a drive section configured to drive said emitting section on the basis of a power supply voltage supplied from a power supply section and the error signal; and
a power supply voltage control section configured to vary the power supply voltage to be supplied from the power supply section to said drive section to maintain consumption power in said drive section constant in accordance with an operation state of said emitting section.

2. A drive according to claim 1, further comprising:
a voltage detection section configured to detect a laser operation voltage generated by said emitting section driven by said drive section, and
wherein said power supply voltage control section controls the level of the power supply voltage of said power supply section to be supplied to said drive section in accordance with a level of the laser operation voltage detected by said voltage detection section.

3. A drive according to claim 1, further comprising:
a current detection section configured to detect a laser operation current generated by said emitting section driven by said drive section, and
wherein said power supply voltage control section controls the level of the power supply voltage of said power supply section to be supplied to said drive section in accordance with a level of the laser operation current detected by said current detection section.

4. A drive according to claim 1, further comprising:
a temperature detection section configured to detect a temperature of said emitting section, and
wherein said power supply voltage control section controls the level of the power supply voltage of said power supply section to be supplied to said drive section in accordance with a temperature level detected by said temperature detection section.

5. A drive according to claim 1, further comprising:
a recording/reproduction control section configured to control recording of data on said disc and reproduction of data recorded on said disc by the laser beam emitted by said emitting section, and
wherein said power supply voltage control section controls the level of the power supply voltage of said power supply section to be supplied to said drive section in accordance with a recording/reproduction control state by said recording/reproduction control section.

6. A laser beam drive power supply voltage control method of an optical disc drive in which an emitting section emitting a disc with a laser beam, and a drive section driving the emitting section, and a power supply section supplying the drive section to a power supply voltage, comprising the steps of:
receiving the laser beam emitted by said emitting section;
converting the received laser beam into an electrical signal;
comparing a level of the electrical signal with a level of a reference electrical signal;
outputting an error signal on the basis of the comparing result;
driving said emitting section on the basis of said power supply voltage supplied from said power supply section and the error signal; and
varying the power supply voltage to be supplied from said power supply section to said drive section to maintain consumption power in said drive section constant in accordance with an operation state of said emitting section.
